(19) United States
(12) Patent Application Publication
(10) Pub. No.: US 2015/0111559 A1
(43) Pub. Date: Apr. 23, 2015

(54) SYSTEM, METHOD AND ARTICLE FOR MANAGING MOBILE DEVICES

(71) Applicant: Recurring Ventures LLC, Seattle, WA (US)

(72) Inventors: Randy Leaver, Spokane, WA (US); Troy Hartzell, Seattle, WA (US); Kirk Van Alstyne, Seattle, WA (US); Fiona Van Alstyne, Seattle, WA (US)

(21) Appl. No.: 14/522,464

(22) Filed: Oct. 23, 2014

Related U.S. Application Data
(60) Provisional application No. 61/894,739, filed on Oct. 23, 2013.

(51) Int. Cl. H04W 8/22

(52) U.S. Cl. CPC H04W 8/22
USPC 455/418

(57) ABSTRACT

A parent mobile device sends a communication to a child mobile device, such as a phone call or an SMS message. The child device has an application installed which responds to the communication by determining whether receipt of the communication satisfies a mobile-device-lock-down criteria. When the communication satisfies the lock down criteria, the mobile device selectively limits functionality of the mobile device based on the determination. A child using the mobile device may attempt to unlock the device, for example, by returning a phone call to the parent device. When an attempt is made to unlock the mobile device, the application determines whether the attempt satisfies a mobile-device-unlock criteria. The application selectively restores functionality of the mobile device based on the determination of whether the attempt satisfies the mobile-device-unlock criteria.

### BACKGROUND

1. Technical Field

The present disclosure relates to systems, methods and articles for managing mobile devices.

2. Description of the Related Art

Parents may provide mobile devices, such as cell phones, to their children in an effort to communicate with them remotely, providing a tool for safety and convenience. Children often choose to dodge or avoid their parent's calls, or ignore the attempts being made by their parents to reach them via phone calls, texts, or other methods of communication via their mobile devices.

Similarly, employers may provide mobile devices to their employees to facilitate communication. Employees often choose to dodge or avoid their employers/offices calls or ignore the attempts being made by their employers/offices to reach them via phone calls, texts, or other methods of communication via their mobile devices.

### BRIEF SUMMARY

In an embodiment, a method comprises: responding, by one or more configured processing devices, to receipt of a communication by a mobile device by: determining whether receipt of the communication satisfies a mobile-device-lock-down criteria; and selectively limiting functionality of the mobile device based on the determination of whether receipt of the communication satisfies the device-lock-down criteria; and responding, by the one or more configured processing devices, to an indication of an attempt to unlock the mobile device by: determining whether the attempt satisfies a mobile-device-unlock criteria; and selectively restoring functionality of the mobile device based on the determination of whether the attempt satisfies the mobile-device-unlock criteria. In an embodiment, the received communication is one of: a telephone call to a phone number associated with the device; an SMS message to a phone number associated with the device; and an email to an address associated with the device. In an embodiment, the determining whether receipt of the communication satisfies a device-lock-down criteria includes determining a source of the received communication. In an embodiment, the determining whether receipt of the communication satisfies a device-lock-down criteria is based on whether a threshold number of communications associated with the device-lock-down criteria have been received. In an embodiment, the determining whether receipt of the communication satisfies a device-lock-down criteria is based on whether a threshold number of communications associated with the device-lock-down criteria have been received within a threshold period of time. In an embodiment, selectively limiting functionality of the device based on the determination of whether receipt of the communication satisfies the device-lock-down criteria comprises limiting the functionality to particular types of communications. In an embodiment, selectively limiting functionality of the device based on the determination of whether receipt of the communication satisfies the device-lock-down criteria comprises limiting the functionality to one or more of calling particular phone numbers, texting particular phone numbers, and sending an email message to particular email addresses. In an embodiment, the determining whether the attempt satisfies a device-unlock criteria includes determining whether the attempt includes a phone call to an unlock phone number. In an embodiment, the determining whether the attempt satisfies a device-unlock criteria includes determining whether a duration of the phone call exceeds a threshold duration. In an embodiment, the method comprises configuring a mobile device management application loaded on the mobile device and configured to manage the responding to the receipt of the communication and the responding to the indication of the attempt. In an embodiment, the method comprises: responding to a manual lock command by locking the mobile device; and responding to a manual unlock command by unlocking the mobile device. In an embodiment, the one or more configured processing devices are one or more processing devices of the mobile device.

In an embodiment, a system comprises: one or more memories; and processing circuitry, which, in operation:responds to receipt of a communication by a mobile device by: determining whether receipt of the communication satisfies a mobile-device-lock-down criteria; and selectively limiting functionality of the mobile device based on the determination of whether receipt of the communication satisfies the device-lock-down criteria; and responds to an indication of an attempt to unlock the mobile device by: determining whether the attempt satisfies a mobile-device-unlock criteria; and selectively restoring functionality of the mobile device based on the determination of whether the attempt satisfies the mobile-device-unlock criteria. In an embodiment, the received communication is one of: a telephone call to a phone number associated with the device; an SMS message to a phone number associated with the device; and an email to an address associated with the device. In an embodiment, the determining whether receipt of the communication satisfies a device-lock-down criteria includes determining a source of the received communication. In an embodiment, the determining whether receipt of the communication satisfies a device-lock-down criteria is based on whether a threshold number of communications associated with the device-lock-down criteria have been received. In an embodiment, the determining whether receipt of the communication satisfies a device-lock-down criteria is based on whether a threshold number of communications associated with the device-lock-down criteria have been received within a threshold period of time. In an embodiment, selectively limiting functionality of the device based on the determination of whether receipt of the communication satisfies the device-lock-down criteria comprises limiting the functionality to particular types of communications. In an embodiment, selectively limiting functionality of the device based on the determination of whether receipt of the communication satisfies the device-lock-down criteria comprises limiting the functionality to one or more of calling particular phone numbers, texting particular phone numbers, and sending an email message to particular email addresses. In an embodiment, the determining whether the attempt satisfies a device-unlock criteria includes determining whether the attempt includes a phone call to an unlock phone number. In an embodiment, the determining whether the attempt satisfies a device-unlock criteria includes determining whether a duration of the phone call exceeds a threshold duration. In an embodiment, the processing circuitry comprises one or more processing devices of the mobile device which, in operation, execute a mobile device management application loaded on a memory of the mobile device and configured to manage the responding to the receipt of the communication and the responding to the indication of the attempt by the mobile device. In an embodiment, the circuitry, in operation, responds to a manual lock command by locking the mobile device; and responds to a manual unlock command by unlocking the mobile device.

In an embodiment, a non-transitory computer-readable medium's contents configure processing circuitry to perform a method, the method comprising: responding to receipt of a communication by a mobile device by: determining whether receipt of the communication satisfies a mobile-device-lock-down criteria; and selectively limiting functionality of the mobile device based on the determination of whether receipt of the communication satisfies the device-lock-down criteria; and responding to an indication of an attempt to unlock the mobile device by: determining whether the attempt satisfies a mobile-device-unlock criteria; and selectively restoring functionality of the mobile device based on the determination of whether the attempt satisfies the mobile-device-unlock criteria. In an embodiment, the received communication is one of: a telephone call to a phone number associated with the device; an SMS message to a phone number associated with the device; and an email to an address associated with the device. In an embodiment, the determining whether receipt of the communication satisfies a device-lock-down criteria includes determining a source of the received communication. In an embodiment, selectively limiting functionality of the device based on the determination of whether receipt of the communication satisfies the device-lock-down criteria comprises limiting the functionality to particular types of communications. In an embodiment, the medium is a memory of the mobile device and the contents comprise a mobile device management application.

### BRIEF DESCRIPTION OF THE SEVERAL VIEWS OF THE DRAWING(S)

FIG. 1 is a flow chart illustrating operation of an embodiment of mobile device management method.

FIG. 2 is a functional block diagram of an embodiment of an environment suitable for providing mobile device management according to at least one illustrated embodiment.

FIGS. 3-5 illustrate example screens that may be presented to users of a mobile device management system/application.

FIG. 6 illustrates an embodiment of a system in which a mobile device management application may be implemented.

### DETAILED DESCRIPTION

In the following description, certain details are set forth in order to provide a thorough understanding of various embodiments of devices, systems, methods and articles. However, one of skill in the art will understand that other embodiments may be practiced without these details. In other instances, well-known structures and methods associated with, for example, mobile devices such as smart phones, tablets, and laptops, etc., computing systems, virtual computing systems, telecommunication networks, web browsers, web servers, etc., have not been shown or described in detail in some figures to avoid unnecessarily obscuring descriptions of the embodiments.

Unless the context requires otherwise, throughout the specification and claims which follow, the word “comprise” and variations thereof, such as “comprising,” and “comprises,” are to be construed in an open, inclusive sense, that is, as “including, but not limited to.”

Reference throughout this specification to “one embodiment,” or “an embodiment” means that a particular feature, structure or characteristic described in connection with the embodiment is included in at least one embodiment. Thus, the appearances of the phrases “in one embodiment,” or “in an embodiment” in various places throughout this specification are not necessarily referring to the same embodiment, or to all embodiments. Furthermore, the particular features, structures, or characteristics may be combined in any suitable manner in one or more embodiments to obtain further embodiments.

The headings are provided for convenience only, and do not interpret the scope or meaning of this disclosure or the claimed invention.

The sizes and relative positions of elements in the drawings are not necessarily drawn to scale. For example, the shapes of various elements and angles are not drawn to scale, and some of these elements are enlarged and positioned to improve drawing legibility. Further, the particular shapes of the elements as drawn are not necessarily intended to convey any information regarding the actual shape of particular elements, and have been selected solely for ease of recognition in the drawings.

Parents are provisioning devices to their children in an effort to communicate with them remotely, providing a tool for safety and convenience. Children will be children, and often choose to dodge or avoid their parent's calls, or ignore the attempts being made by their parents to reach them via phone calls, texts, or other methods of communication via their mobile devices. An embodiment provides a set of tools to parents allowing the parent to facilitate forcing the child to reciprocate communication via their mobile device or have specific functions or services disabled or locked on their child's device until they reciprocate communication.

Enterprises are provisioning or paying for mobile devices for their employees. Given the primary utility of these devices are intended for business means, employers lack an ability to prioritize the types of communications that are taking place on these corporate devices. Employees often choose to dodge or avoid their employers/offices calls or ignore the attempts being made by their employers/offices to reach them via phone calls, texts, or other methods of communication via their mobile devices. An embodiment provides a set of tools to employers allowing the employer to facilitate forcing the employee to reciprocate communication via their mobile device or have specific functions or services disabled or locked on the employee's device until they reciprocate communication.

Unlike existing mobile device management suites that have a “lock” feature available that can only be controlled from the cloud, or server side management console, an embodiment locks the device from the server (or from the device itself), and allows access to only a selected set of services (i.e. device is locked down except for access to the radio to call back a specific phone number (or numbers)) that would enable the client (not the server) to reinstate services or unlock the device by performing that specific task on the device. Additional criteria may be employed in some embodiments to reinstate disabled services or unlock the device (e.g., the device calls back a specific number and does not disconnect for a threshold period of time).

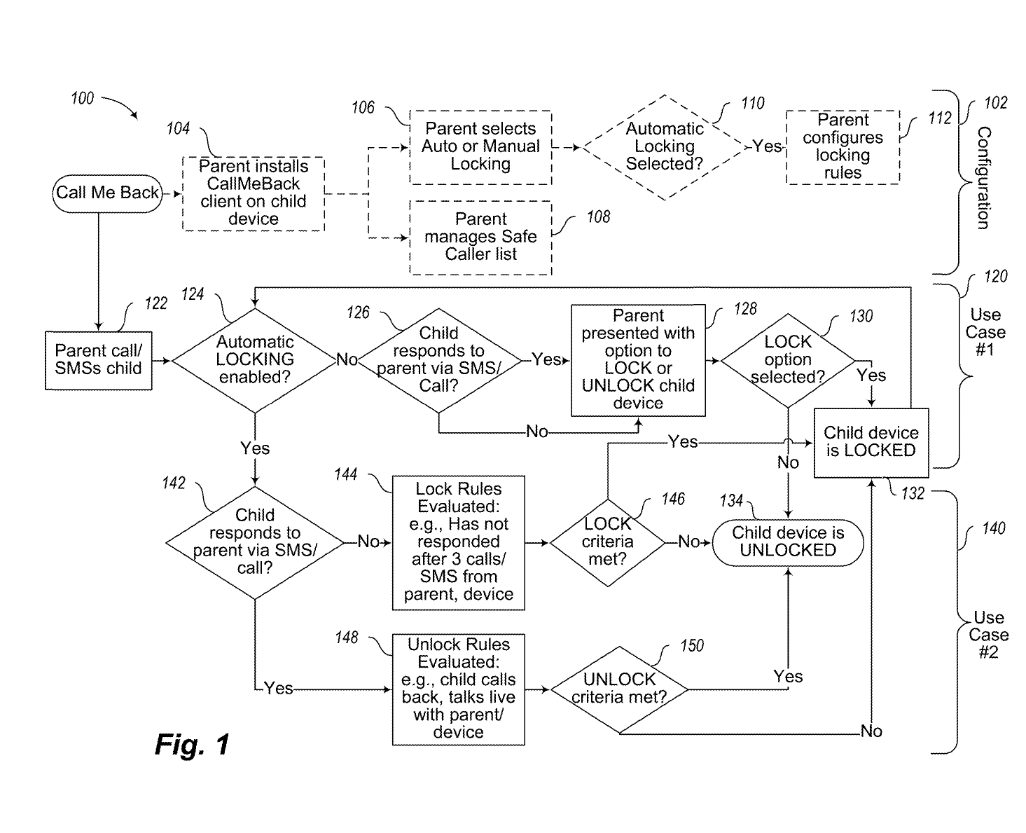

FIG. 1 illustrates an embodiment of a method 100 of controlling a mobile device using an application, such as an application to encourage a user to respond to a communication from another device, loaded on the mobile device and/or devices. Embodiments of an application may take the form of one or more computer programs, modules, etc., executing on one or more processing devices. Applications may be referred to herein as “Apps.” The Apps may be marketed in connection with various trademarks and trade names, such as CALL ME BACK, RECURRING VENTURES, etc. Illustrated embodiments may be described with reference to a parent (or parent device) and a child (or child device), with an application or application module running on one or more of the devices. Embodiments may be employed in other situations (e.g., employer/employee, spouse A/spouse B, etc.).

In a configuration stage 102, a parent may install an application client on a child device at act 104. At act 106, the parent may select auto or manual locking, or some combination thereof. At act 108, the parent may manage a safe caller list. When automatic locking is selected, a system at act 110 may decide to present the parent with configuration options, and the parent may configure the locking rules at act 112.

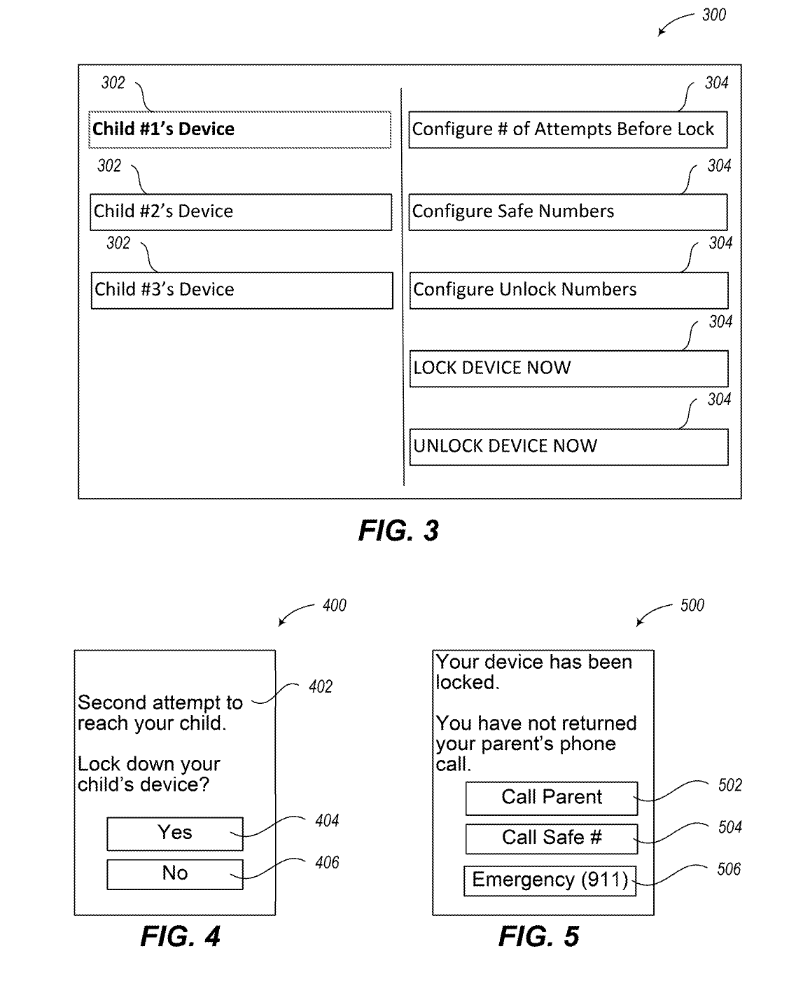

In an embodiment, system registration and/or configuration may occur. For example, a parent may register an App with an application service or server (e.g., via a mobile app or web console interface, etc.). For example, a parent may register for an account via web or through app download @ app store, etc. In an embodiment, the parent user selects which devices are to be added to the platform for management. The application or application module is installed on the selected devices (e.g., child devices) and configured to manage operation of the devices. FIG. 3 shows an example of a system registration and configuration screen 300 that may appear during configuration of a child device app installation, for example on a console or application interface accessed on a parent device (e.g., mobile phone, tablet, PC/Mac, etc.) to facilitate selection of a child device to configure. In at least some embodiments, the application is configured to run in the back ground of the device once provisioned to the managed device(s). As illustrated, the screen 300 includes selection options or buttons 302 to select a device to configure, and selection options or buttons 304 to configure the system response for a selected device, such as a number of unsuccessful attempts to trigger a lock, safe numbers that may be called when the device is locked, numbers which may be called to unlock the device, manual lock now and unlock now selections, etc.

In an embodiment, the parent creates a list of phone numbers that may be used by the child to unlock the device once it has been “locked down or services disabled” by the system (the “Unlock Numbers”)—multiple numbers may be used. In at least some embodiments, only communications (e.g., telephone calls, text messages, etc.) from these Unlock Numbers that are made to the child's device may invoke the “lock down or disabling of services” if they are not responded to. In at least some embodiments, other received communications may trigger a lock-down of a device, such as receiving a communication from one or more particular email addresses. In at least some embodiments, the only way to unlock a locked device is to communicate with one of the Unlock Numbers (e.g., call the number, send a text message, etc.). In at least some embodiments, other communications may be used to unlock a device, such as sending an email to one or more particular email addresses. In at least some embodiments, additional numbers (the “Safe Numbers”, e.g., 911, grandma's number), may be used to unlock a device, even if an ignored call from one of the numbers would not lock the device.

It is noted that in some embodiments, a set of numbers/addresses whose communications may trigger locking of a device, a set of numbers/addresses which may be used to unlock the device, a set of numbers/address which are designated as safe numbers/addresses for the device, may or may not have one or more set members in common.

During configuration, a user, such as a parent, may set call/response management rules, such as (i) a number of attempts to contact a child's device prior to locking down or disabling services; (ii) Acceptable responses, such as calls of specified duration (e.g., a child cannot just call a number back and then hang up), SMS messages of a certain size (e.g., cannot just text back random response to unlock device). At least some embodiments will include a feature wherein a parent can promptly manually lock or disable services on the child device, or manually reinstate services or unlocking of the child's device. For example, a “lock now” and/or an “unlock now” selection may be provided in a mobile device management application interface.

Example user cases are illustrated in FIG. 1 and described below with reference to FIGS. 1, 4 and 5. At least some embodiments may include one or more of the described features of the examples, and various combinations thereof.

In example method 100, a child device receives a telephone call or a text message from a telephone number at act 122, for example from a number associated with a parent device or on a list of numbers associated with automatic locking (e.g., an unlock number), etc. At act 124, a determination is made as to whether automatic locking is enabled, for example, a mobile device management application client on the parent device may determine whether automatic locking is enabled. When it is determined at act 124 that automatic locking is not enabled (use case 120, identified as Use Case #1), the method proceeds to act 126, where it is determined whether the child has responded to the phone call or message and the nature of the response. The method proceeds from act 126 to act 128. At act 128, the parent may be presented with information regarding the response or lack thereof (e.g., the response itself, information about reception conditions, etc.) and with options for locking or unlocking the child device. The method 100 proceeds from act 128 to act 130. At act 130, it is determined whether a lock option has been selected by the parent. When it is determined at act 130 that a lock option was selected, the method proceeds to act 132, where the child device is locked. When it is not determined at act 130 that a lock option was selected, the method proceeds to act 134, where the child device is unlocked. For example, in user case number 1, a Mom may call a child. The device management system may present manual options for locking/unlocking or disabling/enabling services on the child's device after each interaction. The child may answer the call in a manner that is acceptable based on the rules made by the parent in the configuration of the system. Once the call has been completed the parent may be provided with a pop up screen giving them the option to manually lock/unlock or disable/enable services on the child's device. If the child does not answer the call, the parent may be provided with a pop up screen giving them the option to manually lock/unlock or disable/enable services on the child's device or defer to preconfigured system rules. FIG. 4 shows an example screen 400 that may appear in response to an unsuccessful attempt to access a child device, for example on a console accessed on a parent device (e.g., mobile phone, tablet, PC/Mac, etc.) to facilitate locking down a child device. A device management system may be preconfigured to present a pop-up screen after each unsuccessful attempt, after a specified number of attempts, etc. The screen may include information 402 related to a contact history with the child device, such as a number of unsuccessful attempts since a previous event, within a threshold time period, etc. The screen may include selection buttons 404, 406 to select whether to lock down a child device. Other options may be presented, such as partial lock down options, etc.

In at least some embodiments, when a device is locked down or disabled, the functionality of the device is limited in accordance with the configuration information specified by the parent for the device in lock down mode, For example, the child device may only have the ability to either dial or SMS a safe number or an unlock number. FIG. 5 shows an example screen 500 that may appear on a child device that is locked down, to present options available to the child while the device is in lock down mode. The screen 500 may include selection buttons 502, 504, 506 for the options available in lock down mode, such as calling a parent device 502, calling a safe number 504 or calling an emergency number 506.

In some embodiments, if a safe number is used by the child's device, an unlock number may receive an SMS informing the parent which numbers have been used (e.g., if the child calls an uncle or 911 a text will be sent to the parent stating that the child has just called the uncle or 911). Calls or SMS made to safe numbers will not necessarily unlock broader functionality or services of the child's device.

In at least some embodiments, calls or texts to unlock numbers are checked for acceptableness based on the rules made by the parent in the configuration of the system. Once the acceptable call or text has been completed to the unlock number, the parent may be provided with a pop up screen giving them the option to continue to maintain the lock/unlock or disabling/enabling of services on the child's device or reinstate the child's device's functionality in whole or in part.

In at least some embodiments, calls to a safe number may be allowed when a device is in a lock-down mode, but such calls may not satisfy a lock-down criteria. In some embodiments, multiple safe number lists may be employed. In some embodiments, contact lists from other applications may be incorporated into and/or used instead of safe lists. For example, an “in case of emergency” call list that can be accessed from a lock screen in some devices may be incorporated into or used as a safe number list.

In at least some embodiments, conflicts between a mobile device management application as disclosed herein and other mobile device applications may be addressed. For example, in some embodiments the mobile device management application may control when conflicts arise with other applications regarding functionality available on a child device, a parent may be informed of conflicting settings and asked to confirm a default conflict control procedure, etc., and various combinations thereof.

When it is determined at act 124 that automatic locking is enabled (use case 140, identified in FIG. 1 as Use Case 2), the method 100 proceeds to act 142. At act 142, the system determines whether a child has responded to the communication from the parent, e.g., by answering a call, sending an SMS message, returning a call, performing other specified acts (e.g., starting to return home), etc. For example, a Mom may call a child, and the system may rely on preconfigured system rules for lock down or disabling of services on the child's device and acceptable responses to unlock or reinstate services. A parent may attempts to communicate to the child's device, for example, by a mobile phone call or SMS from an Unlock Number.

When it is determined at act 142 that the child has not responded to the communication, the method proceeds to act 144, where lock rules are evaluated. For example, the number of calls or messages from a parent device which have not been responded to within a threshold period of time, the location of the child device, etc., may be determined. The method proceeds from act 144 to act 146 to determine whether a lock criteria are satisfied, for example based on the evaluations of the lock rules. When it is determined at act 144 that a lock criteria are met, the method proceeds to act 132, where the child device is locked, in whole or in part in accordance with the system configuration. For example, the system may track a number of communication attempts from a parent, and if a child does not respond to a threshold number of communication attempts, a lock criteria may be determined to be satisfied and the system may lock the child device or disable one or more services of the child device. For example, the functionality on the child device may be limited to the ability to either dial or SMS a safe number or an unlock number.

When it is not determined at act 144 that a lock criteria are met, the method proceeds to act 134, where the child device is unlocked, in whole or in part in accordance with the system configuration.

When it is determined at act 142 that the child has responded to the call, the method 100 proceeds to act 148, where unlock rules are evaluated, for example, the nature of the response may be determined (e.g., the length of a return call, the length of a text message, whether a text message contains words, etc.), the location of the child device may be determined, etc. The method 100 proceeds from act 148 to act 150 to determine whether an unlock criteria are satisfied (e.g., whether the response is acceptable), for example based on the evaluation of the response is view of the unlock rules. When it is determined at act 150 that an unlock criteria are satisfied, the method proceeds to act 134, where the child device is unlocked, in whole or in part in accordance with the system configuration. When it is not determined at act 150 that an unlock criteria are satisfied, the method proceeds to act 132, where the child device is locked in whole or in part in accordance with the system configuration.

In at least some embodiments, calls or texts to unlock numbers may be checked for acceptableness based on the rules made by the parent in the configuration of the system. Once the acceptable call or text has been completed, services on the child's device may be reinstated. In at least some embodiments, at any point the parent may access the Web console or App on the parent's device that will provide a feature that will allow for the immediate manual lock or disabling of services or the manual reinstating of services or unlocking of the child's device.

In at least some embodiments, restricting one or more functions of a device in a locked mode (e.g., a child device), is performed at the device level (e.g., other functionality, such as attempts to access the Internet, attempts to make phone calls other than to unlock or safe numbers, attempts to send text messages other than to unlock or safe SMS addresses, etc., are blocked or limited at the device interface level, etc.). In at least some embodiments, restricting one or more functions of a locked device is performed at a system level (e.g., a service provider blocks or limits access to services, such as Internet services, calling services, texting services, etc.). For example, a carrier may turn off Internet access to a locked device at a network level. In at least some embodiments, restricting one or more functions of a device in a locked mode may be performed at various levels (e.g., some functions blocked or limited at the device level, some functions blocked or limited at the system level), and at various combinations of levels (e.g., a service provider may permit calls to a list of numbers stored on the device, while restricting calls to other numbers, etc.).

In at least some embodiments, a user, such as a child, is not limited to just phone calls or text to unlock a device; other responses to a communication may unlock a device, such as acceptable communications over the Internet (e.g., VOIP calls, recording a message, etc.), other acceptable actions, such as returning with the device to one or more particular locations, sending an indication of a current location, etc.).

In at least some embodiments, multiple criteria may be employed to determine whether to lock/unlock a device. For example, one un-responded to call from a first number may trigger a lock down when a child device is in a first location, but not trigger a lock down when a child device is in a second location; calls from different lock-down numbers may have different thresholds for triggering a lock down, and different acceptable responses to trigger re-enabling of device functionality, etc., and various combinations thereof.

At least some embodiments may include an SOS component of the application designed for the child (to supplement the safety tools provided to parents). For example, a simple button or ICON on the device that allows the child to press the button or ICON that would let the parent know the child is in trouble, needs to be picked up, and includes the location information. For example, if the child (a teen) is with friends at a party and the child's ride has been drinking and the child does not want to be driving with them, instead of having to dial their parent and ask the parent to come get the child, this provides a simple app for the child to discretely ask for help without having the child's friends see him (or her) make the call to their parents.

In at least some embodiments, functionality of other applications or selections may be modified when a device is operating in a locked or disabled mode. For example, pressing any Icon or button (or some identified subset thereof) may automatically call one of the Unlock Numbers.

In at least some embodiments, the lock/unlock/disable/enable functionality described herein may be partially or fully integrated into other device applications and functionality. For example, the functionality described herein may be fully integrated into a device operating system, device applications (e.g., device calling or SMS Apps, etc.), etc., with the operation system or other device application configured to provide at least some of the functionality of, for example, a CALL ME BACK device management application. In another example, access to functionality of, for example, a CALL ME BACK device management application, may be integrated into the operating system or other applications of a mobile device. For example, the lock/unlock/disable/enable functionality described herein may be integrated into the existing work flow of a phone application and/or an SMS messaging application of the device. For instance, if the mom calls the child and the child does not pick up, when the mom looks at either the contact screen or the call log screen on a parent device, the status of the child device will appear (for example, green is unlocked device—red is locked device) as part of or next to (e.g., an icon) a listing associated with the child and/or the child's device and provide options for locking or unlocking the device as a simple icon (or something similar) next to the child's name. In one embodiment, selecting the child's name and/or an icon next to the child's name may toggle the child device status (e.g., from locked (red) to unlocked (green)) or cause an option menu to appear where the status or configuration for the child device may be modified. In another example, when a child device is starting up, a call history or missed call list on the child's device may be accessed and used to determine whether a lock-down criteria is satisfied based on calls received while the device was turned off.

At least some embodiments may include functionality to limit a child's ability to modify a device management app. For example, changes to the configuration of a Child device management app may only be permitted when the child device and the parent device are connected to a device management service (e.g., when both devices are logged onto a server of a device management service). In another example, a configuration of a Child device management app may only be permitted with the Child device and the Parent device are directly communicating with each other (e.g., when a Bluetooth or other local area network connection exists between the devices). In another example, changes to a child device configuration may be limited to changes entered through an interface on the parent device.

At least some embodiments may provide additional and/or other functionality, such as combining telephone services with text messaging services. For example, when placing a call to a child's device, a parent may be presented with an option to simultaneously send an SMS text message. For example, a parent may send a message indicating a call is important (e.g., “your father has been in an accident, so please answer the phone,” etc.) The SMS message may appear next to or instead of a caller ID. Other messages including automatic messages, may be employed (e.g., “You must answer the next call or your device will be disabled,” “If this call is not returned within 5 minutes, your phone will be disabled,” etc.). In some embodiments, a parent may be presented with an option to send an SMS text message in response to a call not being answered by a child device.

At least some embodiments may provide the parent device with usage information related to the child device and/or employ usage information related to the child device in determining whether criteria, such as lock and/or unlock criteria, are satisfied. For example, if a parent calls a child device and a call is not answered, the parent device may be provided with one or more indications of usage conditions of the child device (e.g., whether the device is or recently was outside a provider service area, when the child device was last used, what was the nature of the last use (e.g., to call another parent, to play a game, etc.), whether the child device is currently on an active call and/or download, how long a current call has lasted, etc.). In another example, recent and/or current usage information may be employed as part of the criteria for determining whether to lock or unlock a child device.

At least some embodiments may employ a carrot and/or a stick approach. For example, instead of and/or in addition to locking a child device in response to unresponsiveness on the part of the child, good behavior may be rewarded. For example, if a child satisfies reward criteria (e.g., regularly answers or promptly returns phone calls from a parent device, etc.), additional services may be enabled or provided, such as extra minutes of air time, extra text messaging credits, credits to purchase and/or use applications (e.g., extra money applied to an account which may be used to purchase songs, game playing time, etc.), etc.

At least some embodiments may employ fuzzy logic, point systems, thresholds, scaling, etc., and various combinations thereof, in order to determine whether criteria (such as lock, unlock, reward, etc.), are satisfied and/or the appropriate responses to satisfying a particular criteria.

In at least some embodiments, an app to manage a device may be obtained via one or more third-party servers, such as servers providing application store services (e.g., Microsoft's WINDOWS STORE, Apple's APP STORE, Amazon's APPSTORE, etc.). For example, a device management service provider may distribute application modules through a third-party server, such as a third-party server providing application download services. A parent device may obtain a copy of one or more application modules (e.g., a module to configure the parent device and a module to configure a child device) configured to provide device management functionality as described herein from such a third-party server. The communications associated with downloading application modules may include both wireless (Over-The-Air, Wi-Fi, etc.) and wired communication links. In at least some embodiment, a parent device may download a child module and then install the child module on the child device. In at least some embodiments, the child device may download one or more modules from a third-party server. The modules may then allow the parent device to manage the functionality of a child device, for example, as described herein.

The following discussion provides a brief, general description of a suitable computing environment in which the embodiments described herein may be implemented. Although not required, various embodiments will be described in the general context of computer-executable instructions, such as program application modules, objects, or macros being executed by one or more electronic devices, such as a smart phone, a tablet, a personal computer, a server, etc., and various combinations thereof. Those skilled in the relevant art will appreciate that various embodiments can be practiced with other computing system configurations, including other handheld devices, multiprocessor systems, microprocessor-based or programmable consumer electronics, networked personal computers (PCs), minicomputers, mainframe computers, virtual systems, and the like. Various embodiments can be practiced in distributed computing environments where tasks or modules are performed by remote processing devices, which are linked through a communications network. In a distributed computing environment, program modules may be located in both local and remote memory storage devices.

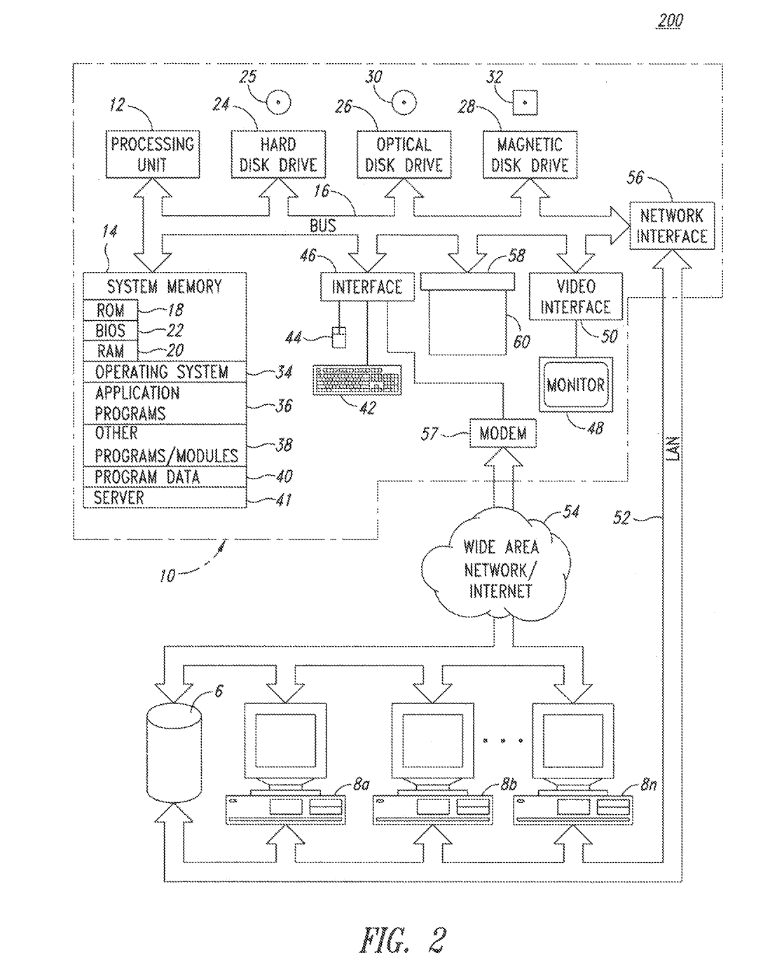

FIG. 2 shows an embodiment of an environment 200 that may be employed as a device (e.g., a child device) and/or to facilitate management of a device (e.g., as a parent device or server to facilitate management of a child device) as described herein. The environment 200 includes a computing system 10. For example, the computing system 10 may be configured as a smart phone, a tablet, a host server, such as a communications server, etc. The computing system 10 may, for example, be operated by a business providing goods or services to a consumer (such as an applications provider, a telecommunications provider, etc.), by a user managing a mobile device (such as a parent managing a child's mobile device, an employer managing an employee's mobile device, etc.), by a vendor, such as a communication service provider (for example, a telecom service provider, an Internet service provider, an application provider), etc. The computing system 10 may take the form of any of the variety of types discussed above, which may run a networking client, for example a server, a Web browser, a telecommunications module, etc. The computing system 10 comprises a processor unit 12, a system memory 14 and a system bus 16 that couples various system components including the system memory 14 to the processing unit 12. The processing unit 12 may be any logical processing unit, such as one or more central processing units (CPUs), digital signal processors (DSPs), application-specific integrated circuits (ASIC), etc. Unless described otherwise, the construction and operation of the various blocks shown in FIG. 2 are of conventional design. As a result, such blocks need not be described in further detail herein, as they will be understood by those skilled in the relevant art.

The system bus 16 can employ any known bus structures or architectures, including a memory bus with memory controller, a peripheral bus, and/or a local bus. The system memory 14 includes read-only memory (“ROM”) 18 and random access memory (“RAM”) 20. A basic input/output system (“BIOS”) 22, which can form part of the ROM 18, contains basic routines that help transfer information between elements within the computing system 10, such as during startup.

The computing system 10 also includes one or more optional spinning media memories such as a hard disk drive 24 for reading from and writing to a hard disk 25, and an optical disk drive 26 and a magnetic disk drive 28 for reading from and writing to removable optical disks 30 and magnetic disks 32, respectively. The optical disk 30 can be a CD-ROM, while the magnetic disk 32 can be a magnetic floppy disk or diskette. The hard disk drive 24, optical disk drive 26 and magnetic disk drive 28 communicate with the processing unit 12 via the bus 16. The hard disk drive 24, optical disk drive 26 and magnetic disk drive 28 may include interfaces or controllers coupled between such drives and the bus 16, as is known by those skilled in the relevant art, for example via an IDE (Integrated Drive Electronics) interface, a SATA interface, etc. The drives 24, 26 and 28, and their associated computer-readable media, provide nonvolatile storage of computer-readable instructions, data structures, program modules and other data for the computing system 10. Although the depicted computing system 10 employs hard disk 25, optical disk 30 and magnetic disk 32, those skilled in the relevant art will appreciate that other types of spinning media memory computer-readable media may be employed, such as, digital video disks (DVD), Bernoulli cartridges, etc. Those skilled in the relevant art will also appreciate that other types of computer-readable media that can store data accessible by a computer may be employed, for example, non-spinning media memories such as magnetic cassettes, flash memory cards, RAMs, ROMs, smart cards, etc.

Program modules can be stored in the system memory 14, such as an operating system 34 (for example, WINDOWS, ANDROID, iOS, Mac OS, etc), one or more application programs 36, other programs or modules 38, and program data 40. For example, a device management app may be stored in the system memory 14. The system memory 14 also includes a server 41 for permitting the computing system 10 to exchange data with sources such as Websites of the Internet, corporate intranets, or other networks, as well as other server applications on server computers. The server 41 may be markup language based, such as hypertext markup language (HTML), and operate with markup languages that use syntactically delimited characters added to the data of a document to represent the structure of the document, etc.

While shown in FIG. 2 as being stored in the system memory 14, the operating system 34, application programs 36, other program modules 38, program data 40 and server 41 can be stored on the hard disk 25 of the hard disk drive 24, the optical disk 30 and the optical disk drive 26 and/or the magnetic disk 32 of the magnetic disk drive 28. A user can enter commands and information to the computing system 10 through input devices such as a keypad or keyboard 42 and a pointing device such as a mouse 44. Other input devices can include a microphone, joystick, game pad, scanner, touch screen, card reader, chip reader, etc. These and other input devices as illustrated are connected to the processing unit 12 through an interface 46 such as a serial port interface that couples to the bus 16, although other interfaces such as a parallel port, a game port or a universal serial bus (USB) can be used. A display or monitor 48 or other display devices may be coupled to the bus 16 via video interface 50, such as a video adapter. The computing system 10 can include other output devices such as speakers, printers, etc.

The computing system 10 can operate in a networked environment using logical connections to one or more repositories 6 and/or other computing systems 8a-8n. The computer system 10 may employ any known means of communications, such as through a local area network (LAN) 52 or a wide area network (WAN), a telecommunications network or the Internet 54. Such networking environments are well known and may include, for example, any type of telecommunications network or other network, such as CDMA, WCDMA, OFDMA, GSM, 3GPP, LTE, WiMAX, VoIP, HSPA, WiFi, Internet Protocol, various IEEE standard protocols, etc.

When used in a LAN networking environment, the computing system 10 may be coupled to the LAN 52 through an adapter or network interface 56 (communicatively linked to the bus 16). When used in a WAN networking environment, the computing system 10 often includes a device, such as a modem 57, a mobile phone communication module or other device for establishing communications over the WAN/Internet 54. As illustrated, a modem 57 is shown in FIG. 2 as communicatively linked between the interface 46 and the WAN/Internet/Telecommunications network 54. In a networked environment, program modules, application programs, or data, or portions thereof, can be stored in a server computer (for example, another configured computing system similar to the computing system 10). Those skilled in the relevant art will readily recognize that the network connections shown in FIG. 2 a are only some examples of establishing communication links between computers and/or other systems and devices 60, and other links may be used, including wireless links.

The computing system 10 may include one or more interfaces such as slot 58 to allow the addition of devices either internally or externally to the computing system 10. For example, suitable interfaces may include ISA (Industry Standard Architecture), IDE, PCI (Personal Computer Interface), SATA, and/or AGP (Advance Graphics Processor) slot connectors for option cards, serial and/or parallel ports, USB ports (Universal Serial Bus), audio input/output (I/O) and MIDI/joystick connectors, slots for memory, credit card readers, scanners, bar code readers, RFID readers, etc., collectively referenced as 60.

The term computer-readable medium as used herein refers to any medium that participates in providing instructions or data to processor unit 12 for execution. Such a medium may take many forms, including but not limited to, non-volatile media, and volatile media. Non-volatile media includes, for example, hard, optical or magnetic disks 25, 30, 32, respectively. Volatile media includes dynamic memory, such as system memory 14.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, as described hereinafter, or any other medium from which a computer can read.

Various forms of computer readable media may be involved in carrying one or more sequences of one or more instructions to processor unit 12 for execution. For example, the instructions may initially be carried on a magnetic disk of a remote computer. The remote computer can load the instructions into its dynamic memory and send the instructions over a telephone line using a modem. A modem 57 local to computer system 10 can receive the data on the telephone line and use an infrared transmitter to convert the data to an infrared signal. An infrared detector coupled to the system bus 16 can receive the data carried in the infrared signal and place the data on system bus 16. The system bus 16 carries the data to system memory 14, from which processor unit 12 retrieves and executes the instructions. The instructions received by system memory 14 may optionally be stored on storage device either before or after execution by processor unit 12.

The repository 6 is a permanent storage medium for data. The repository 6 may be specific to each end user, or shared between some or all end users. For example, different services vendors (for example, telecommunication vendors, WiFi vendors, device management service vendors, etc.) may have separate repositories or may share repositories. The repository 6 (only one illustrated) may run on the same computing system as an application accessing the repository, or on another computing system accessible over the network 52, 54.

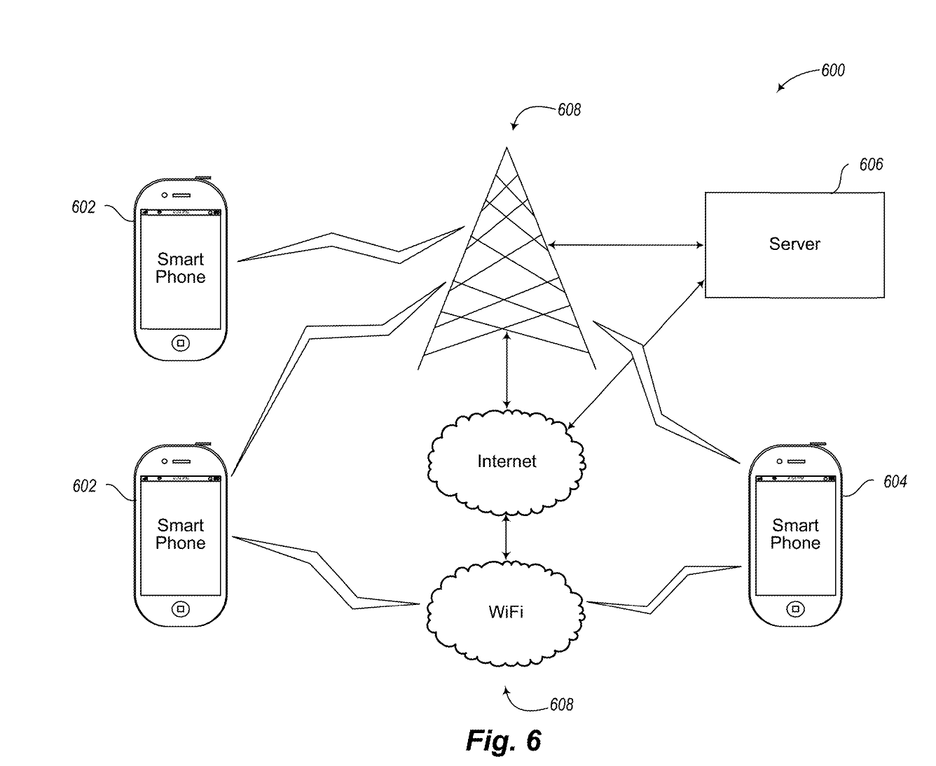

Embodiments of the computing system 10 of FIG. 2 may not include all of the illustrated components of the computing system 10, may contain additional components not shown in FIG. 10, and may not be configured as shown in FIG. 10. For example, a computing system 10 configured as smart phone system (see FIG. 6), may not include an optical disk drive and may include an application specific integrated circuit or a digital signal processor (not shown) to perform one or more of the functions of the smart phone system. In another example, a smart phone system may include one or more telecommunications modules to handle call processing, such as CDMA, OFDMA, GSM, etc., call processing.

FIG. 6 is a functional block diagram of an embodiment of a system 600. The system 600 includes one or more child devices (e.g., smart phones) 602, one or more parent devices (e.g., smart phones) 604 and one or more servers 606, which may typically be remote from the devices 602, 604. The devices 602, 604 and the servers 606 may communicate over one or more communication networks 608. A provider of a device management app may use one or more servers 606 in communication with a parent device 604 to install and/or configure a device management app installed on a child device 602. The devices 602, 604, servers 606 and communication networks 608 may be configured to communication with each other using various wired and wireless communication links. In some embodiments, a parent device 604 may be configured to configure a child device management app while in direct communication with a child device 602.

Embodiments of methods of managing a device as described herein may contain additional acts not shown in the Figures, may not contain all of the acts shown in the Figures, may perform acts shown in the Figures in various orders, and may be modified in various respects. For example, additional acts such as limiting the services available on a device until additional actions occur may be performed in some embodiments. For example, if a child device attempts an unlock by calling an Unlock Number and is only able to leave a voice mail, the child device may be required to attempt to call a second Unlock Number before functionality is restored. In another example, the extent to which functionality is restored may be dependent on the action taken to attempt to restore functionality (e.g., calling an unlock number which is different from an unlock number associated with the lock down may only partially restore device functionality, etc.)

Some embodiments may take the form of or comprise computer program products. For example, according to one embodiment there is provided a computer readable medium comprising a computer program adapted to perform one or more of the methods or functions described above. The medium may be a physical storage medium such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), state machines, field-programmable gate arrays (FPGAs), complex programmable logic devices (CPLDs), etc., as well as devices that employ RFID technology, and various combinations thereof. For example, embodiments of a device may be implemented as discussed above (e.g., partially in hardware, partially with controllers executing instructions, etc.).

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
responding, by one or more configured processing devices, to receipt of a communication by a mobile device by:
determining whether receipt of the communication satisfies a mobile-device-lock-down criteria; and
selectively limiting functionality of the mobile device based on the determination of whether receipt of the communication satisfies the device-lock-down criteria; and
responding, by the one or more configured processing devices, to an indication of an attempt to unlock the mobile device by:
determining whether the attempt satisfies a mobile-device-unlock criteria; and
selectively restoring functionality of the mobile device based on the determination of whether the attempt satisfies the mobile-device-unlock criteria.

2. The method of claim 1 wherein the received communication is one of:
a telephone call to a phone number associated with the device;
an SMS message to a phone number associated with the device; and
an email to an address associated with the device.

3. The method of claim 2 wherein the determining whether receipt of the communication satisfies a device-lock-down criteria includes determining a source of the received communication.

4. The method of claim 1 wherein the determining whether receipt of the communication satisfies a device-lock-down criteria is based on whether a threshold number of communications associated with the device-lock-down criteria have been received.

5. The method of claim 1 wherein the determining whether receipt of the communication satisfies a device-lock-down criteria is based on whether a threshold number of communications associated with the device-lock-down criteria have been received within a threshold period of time.

6. The method of claim 1 wherein selectively limiting functionality of the device based on the determination of whether receipt of the communication satisfies the device-lock-down criteria comprises limiting the functionality to particular types of communications.

7. The method of claim 1 wherein selectively limiting functionality of the device based on the determination of whether receipt of the communication satisfies the device-lock-down criteria comprises limiting the functionality to one or more of calling particular phone numbers, texting particular phone numbers, and sending an email message to particular email addresses.

8. The method of claim 1 wherein the determining whether the attempt satisfies a device-unlock criteria includes determining whether the attempt includes a phone call to an unlock phone number.

9. The method of claim 8 wherein the determining whether the attempt satisfies a device-unlock criteria includes determining whether a duration of the phone call exceeds a threshold duration.

10. The method of claim 1, comprising configuring a mobile device management application loaded on the mobile device and configured to manage the responding to the receipt of the communication and the responding to the indication of the attempt.

11. The method of claim 1, comprising:
responding to a manual lock command by locking the mobile device; and
responding to a manual unlock command by unlocking the mobile device.

12. The method of claim 1 wherein the one or more configured processing devices are one or more processing devices of the mobile device.

13. A system, comprising:
one or more memories; and
processing circuitry, which, in operation:
responds to receipt of a communication by a mobile device by:
determining whether receipt of the communication satisfies a mobile-device-lock-down criteria; and
selectively limiting functionality of the mobile device based on the determination of whether receipt of the communication satisfies the device-lock-down criteria; and
responds to an indication of an attempt to unlock the mobile device by:
determining whether the attempt satisfies a mobile-device-unlock criteria; and
selectively restoring functionality of the mobile device based on the determination of whether the attempt satisfies the mobile-device-unlock criteria.

14. The system of claim 13 wherein the received communication is one of:
a telephone call to a phone number associated with the device;
an SMS message to a phone number associated with the device; and
an email to an address associated with the device.

15. The system of claim 13 wherein the determining whether receipt of the communication satisfies a device-lock-down criteria includes determining a source of the received communication.

16. The system of claim 13 wherein the determining whether receipt of the communication satisfies a device-lock-down criteria is based on whether a threshold number of communications associated with the device-lock-down criteria have been received.

17. The system of claim 13 wherein the determining whether receipt of the communication satisfies a device-lock-down criteria is based on whether a threshold number of communications associated with the device-lock-down criteria have been received within a threshold period of time.

18. The system of claim 13 wherein selectively limiting functionality of the device based on the determination of whether receipt of the communication satisfies the device-lock-down criteria comprises limiting the functionality to particular types of communications.

19. The system of claim 13 wherein selectively limiting functionality of the device based on the determination of whether receipt of the communication satisfies the device-lock-down criteria comprises limiting the functionality to one or more of calling particular phone numbers, texting particular phone numbers, and sending an email message to particular email addresses.

20. The system of claim 13 wherein the determining whether the attempt satisfies a device-unlock criteria includes determining whether the attempt includes a phone call to an unlock phone number.

21. The system of claim 20 wherein the determining whether the attempt satisfies a device-unlock criteria includes determining whether a duration of the phone call exceeds a threshold duration.

22. The system of claim 13 wherein the processing circuitry comprises one or more processing devices of the mobile device which, in operation, execute a mobile device management application loaded on a memory of the mobile device and configured to manage the responding to the receipt of the communication and the responding to the indication of the attempt by the mobile device.

23. The system of claim 13 wherein the circuitry, in operation,
responds to a manual lock command by locking the mobile device; and
responds to a manual unlock command by unlocking the mobile device.

24. A non-transitory computer-readable medium having contents which configure processing circuitry to perform a method, the method comprising:
responding to receipt of a communication by a mobile device by:
determining whether receipt of the communication satisfies a mobile-device-lock-down criteria; and
selectively limiting functionality of the mobile device based on the determination of whether receipt of the communication satisfies the device-lock-down criteria; and
responding to an indication of an attempt to unlock the mobile device by:
determining whether the attempt satisfies a mobile-device-unlock criteria; and
selectively restoring functionality of the mobile device based on the determination of whether the attempt satisfies the mobile-device-unlock criteria.

25. The medium of claim 24 wherein the received communication is one of:
a telephone call to a phone number associated with the device;
an SMS message to a phone number associated with the device; and
an email to an address associated with the device.

26. The medium of claim 24 wherein the determining whether receipt of the communication satisfies a device-lock-down criteria includes determining a source of the received communication.

27. The medium of claim 24 wherein selectively limiting functionality of the device based on the determination of whether receipt of the communication satisfies the device-lock-down criteria comprises limiting the functionality to particular types of communications.

28. The medium of claim 24 wherein the medium is a memory of the mobile device and the contents comprise a mobile device management application.
